(19) United States
(12) Patent Application Publication
(10) Pub. No.: US 2026/0326778 A1
(43) Pub. Date: Oct. 22, 2026

(54) INTELLIGENT VEHICLE PRECISION CONTROLS

(71) Applicant: GM Global Technology Operations LLC, Detroit, MI (US)

(72) Inventors: Anthony J. Sumcad, Rochester Hills, MI (US); Suchinder K. Govindan, Farmington Hills, MI (US)

(21) Appl. No.: 19/185,732

(22) Filed: Apr. 22, 2025

(51) Int. Cl. B60W 50/08; B60W 10/04; B60W 10/18; B60W 10/20; B60W 50/00; B60W 50/14; B60W 50/16

(52) U.S. Cl. CPC B60W 50/085; B60W 10/04; B60W 10/18; B60W 10/20; B60W 50/16; B60W 2050/0004; B60W 2050/0013; B60W 2050/143; B60W 2050/146; B60W 2510/20; B60W 2520/06; B60W 2540/10; B60W 2540/12; B60W 2540/18; B60W 2710/18; B60W 2710/205; B60W 2720/30

(57) ABSTRACT

A system for intelligent vehicle precision controls (IVPC) includes a towing vehicle, and a trailer, connectable to the towing vehicle via a hitch. An IVPC application includes precision adjustment and precision control modes. The IVPC application determines that vehicle operator inputs are being received via physical controls and/or digital controls, prompts the vehicle operator to select between at least: longitudinal and steering inputs, and receives vehicle operator inputs to toggle between the precision adjustment mode and a precision control mode. The precision adjustment mode alters a scale of vehicle operator inputs, while the precision control mode causes vehicle operator inputs to engage the actuators of a powertrain system, braking, and/or steering systems to cause the towing vehicle to move via actuation of actuators of the powertrain, braking and/or steering systems, and precisely maneuver and align the towing vehicle to be connected to the trailer at the hitch.

### INTRODUCTION

The present disclosure relates to vehicle control technologies, and more specifically to systems and methods supporting vehicle operators in attaching towing vehicles to trailers. Typical trailer towing driver assistance systems offer lane keeping, lane centering, and adaptive cruise control. Some trailer towing driver assistance systems also offer optical views of a vehicle trailer hitch, thereby providing vehicle operators with visual cues for attaching the vehicle trailer hitch to trailers.

While current systems and methods of advanced driver assistance system (ADAS) aided or other such active safety system-aided trailer control, and/or trailer attachment assistance systems achieve their intended purpose, there is a need for new and improved systems and methods for intelligent vehicle precision control that increase the ease with which a towing vehicle may be attached to the trailer by a vehicle operator while making use of existing hardware, and while maintaining or reducing system complexity, maintaining or reducing manufacturing complexity, and which may be retrofitted to existing vehicles that are equipped with appropriate hardware, may be remotely updatable, and that offer improved functionality and redundancy, while improving vehicle operator convenience, comfort, and satisfaction.

### SUMMARY

According to several aspects of the present disclosure, a system for intelligent vehicle precision controls includes a towing vehicle, and a trailer, connectable to the towing vehicle via a hitch. One or more sensors are integrated into the towing vehicle, the one or more sensors detecting static and dynamic state information about the towing vehicle. One or more actuators are integrated into the towing vehicle, the one or more actuators altering the static and dynamic state of the towing vehicle. The system further includes a controller having a processor, a memory, and input/output (I/O) ports. The are I/O ports in communication with the one or more sensors and the one or more actuators. The processor executes program code portions stored in the memory. The program code portions include an intelligent vehicle precision control (IVPC) application. The IVPC application includes at least first, second, third, fourth, and fifth control logics. The first control logic engages a precision mode of the IVPC application. The second control logic, within the precision mode of the IVPC application, monitors system hardware and determines that vehicle operator inputs to the IVPC application are being received via physical controls and/or digital controls. The third control logic, within the precision mode of the IVPC application, prompts the vehicle operator to select between at least: longitudinal inputs and steering inputs. The fourth control logic, within the precision control mode of the IVPC application, receives vehicle operator inputs to toggle between a precision adjustment mode and a precision control mode. The fifth control logic, in the precision control mode, causes vehicle operator inputs to engage the one or more actuators of a powertrain system and/or the one or more actuators of a steering system. The vehicle operator inputs in the precision control mode cause the towing vehicle to move longitudinally via actuation of the one or more actuators of the powertrain system or braking system, and to turn or rotate the towing vehicle via actuation of the one or more actuators of the steering system. Through the IVPC application, the vehicle operator precisely maneuvers the towing vehicle to a position where the towing vehicle and the trailer are aligned to be connected at the hitch.

In another aspect of the present disclosure, the first control logic further includes: control logic that receives, via one or more human-machine interfaces (HMIs) in communication with the controller via the I/O ports, a vehicle operator input that engages the precision mode of the IVPC application. The one or more HMIs include control interfaces of the towing vehicle; an infotainment system of the towing vehicle; a heads-up display (HUD) of the towing vehicle; and vehicle operator-controllable input devices including: buttons, sliders, control wheels, haptic, audiovisual and/or voice-responsive interfaces, touch screens, mobile devices, mobile phones, laptops, and tablet computers.

In yet another aspect of the present disclosure, the second control logic further includes: control logic that monitors the powertrain system and the steering system of the towing vehicle for vehicle operator input sources. Upon determining that the vehicle operator inputs are being received from physical controls, the second control logic utilizes a physical control mode of the IVPC application. Upon determining that the vehicle operator inputs are being received via digital controls, the second control logic utilizes a digital control mode of the IVPC application. Physical controls include: physical HMIs including knobs, buttons, physical sliders, keypads, and directional pads (D-pads); and digital controls include: a touch-screen interface of the infotainment system of the towing vehicle, a touch-screen interface of one or more mobile devices, mobile phones, and laptops.

In still another aspect of the present disclosure the third control logic further includes control logic that: upon receiving a longitudinal input from the vehicle operator, engages actuators of the powertrain system and a braking system of the towing vehicle to generate torque to wheels of the towing vehicle to move forward or backwards; and upon receiving a steering input from the vehicle operator, the third control logic engages actuators of the steering system of the towing vehicle to alter a steering rate, steering velocity, and to adjust a rotational or lateral movement of the towing vehicle.

In still another aspect of the present disclosure the fourth control logic further includes: control logic that selectively toggles between and engages one of a precision adjustment mode and a precision control mode based on a vehicle operator selection.

In still another aspect of the present disclosure the fourth control logic further includes: control logic that, in the precision adjustment mode, alters a scale and magnitude of vehicle operator inputs to the one or more actuators of the powertrain system and to the one or more actuators of the steering system.

In still another aspect of the present disclosure within the precision adjustment mode, the scale and magnitude of vehicle operator inputs is adjusted via one or more of a rotary knob and digital controls such that upon receiving a rightward or clockwise (CW) rotational input to the rotary knob or a rightward or spreading gesture to the digital controls, a scale of the vehicle operator inputs is increased from a first level to a second level larger than the first level; and upon receiving a leftward or counterclockwise (CCW) rotational input to the rotary knob or a leftward or pinching gesture to the digital controls, a scale of the vehicle operator inputs is decreased from the first level to a third level less than the first level.

In still another aspect of the present disclosure the fourth control logic further includes: control logic for continuously checking for movement of the rotary knob or movement of vehicle operator inputs to the digital controls for a predefined quantity of time within a timer or poller of the system, and upon detecting a movement, remaining within the timer, continuing to check for movement, and continuing to alter a scale and magnitude of vehicle operator inputs; and upon detecting no movement within the predefined quantity of time of the timer or poller, the fourth control logic exits the precision mode of the IVPC application.

In still another aspect of the present disclosure within the precision control mode, the scale and magnitude of vehicle operator inputs is adjusted via one or more of a rotary knob and digital controls, such that upon receiving a vehicle operator's rightward or clockwise (CW) rotational input to the rotary knob or a rightward or spreading gesture to the digital controls, the rightward, CW, or spreading inputs or gestures are translated into longitudinal forward movement commands to one or more actuators of the powertrain system or braking system, or into rightward or CW rotational commands to one or more actuators of the steering system; and upon receiving a vehicle operator's leftward or counterclockwise (CCW) rotational input to the rotary knob or a leftward or pinching gesture to the digital controls, the leftward, CCW, or pinching inputs or gestures are translated into longitudinal rearward movement commands to the one or more actuators of the powertrain system or braking system, or into leftward or CCW rotational commands to the one or more actuators of the steering system.

In still another aspect of the present disclosure the fifth control logic further includes: control logic for continuously checking for movement of the rotary knob or movement of vehicle operator inputs to the digital controls for a predefined quantity of time within a timer or poller of the system, and upon detecting a movement, remaining within the timer, continuing to check for movement, and continuing to move the towing vehicle in accordance with the vehicle operator's inputs; and upon detecting no movement within the predefined quantity of time of the timer or poller, the fifth control logic exits the precision mode of the IVPC application.

In still another aspect of the present disclosure a method for intelligent vehicle precision controls includes detecting static and dynamic state information about a towing vehicle with one or more sensors integrated into the towing vehicle, and altering the static and dynamic state of the towing vehicle with one or more actuators integrated into the towing vehicle. The method further includes executing, with a processor of a controller of the towing vehicle, program code portions stored in memory of the controller, the controller having input/output (I/O) ports in communication with the one or more sensors and the one or more actuators, the program code portions including an intelligent vehicle precision control (IVPC) application. The IVPC application includes control logic for: engaging a precision mode of the IVPC application, and monitoring, within the precision mode, towing vehicle hardware and determining that vehicle operator inputs to the IVPC application are being received via physical controls and/or digital controls. The IVPC application further includes control logic for prompting the vehicle operator to select between at least: longitudinal inputs and steering inputs, and receiving vehicle operator inputs to toggle between a precision adjustment mode that scales vehicle operator inputs, and a precision control mode that controls the towing vehicle. The IVPC application further includes control logic for causing vehicle operator inputs to engage the one or more actuators of a powertrain system and/or the one or more actuators of a steering system. The vehicle operator inputs in the precision control mode cause the towing vehicle to move longitudinally via actuation of the one or more actuators of a powertrain system or braking system, and to turn or rotate the towing vehicle via actuation of the one or more actuators of the steering system. Through the IVPC application, the vehicle operator precisely maneuvers the towing vehicle to a position where the towing vehicle and a trailer are aligned to be connected via a hitch.

In still another aspect of the present disclosure, the method for intelligent vehicle precision controls further includes receiving, via one or more human-machine interfaces (HMIs) in communication with the controller via the I/O ports, a vehicle operator input that engages the precision mode of the IVPC application, wherein the one or more HMIs include: control interfaces of the towing vehicle; an infotainment system of the towing vehicle; a heads-up display (HUD) of the towing vehicle; and vehicle operator-controllable input devices including: buttons, sliders, control wheels, haptic, audiovisual and/or voice-responsive interfaces, touch screens, mobile devices, mobile phones, laptops, and tablet computers.

In still another aspect of the present disclosure, the method for intelligent vehicle precision controls further includes monitoring the powertrain system and steering system of the towing vehicle for vehicle operator input sources, and upon determining that the vehicle operator inputs are being received from physical controls, utilizing a physical control mode of the IVPC application, and upon determining that the vehicle operator inputs are being received via digital controls, utilizing a digital control mode of the IVPC application. Physical controls include: physical HMIs including knobs, buttons, physical sliders, keypads, and directional pads (D-pads); and digital controls include: a touch-screen interface of the infotainment system of the towing vehicle, a touch-screen interface of one or more mobile devices, mobile phones, and laptops.

In still another aspect of the present disclosure, upon receiving a longitudinal input from the vehicle operator, the method for intelligent vehicle precision controls engages actuators of the powertrain system and a braking system of the towing vehicle to generate torque to wheels of the towing vehicle to move forward or backwards; and upon receiving a steering input from the vehicle operator, the method engages actuators of the steering system of the towing vehicle to alter a steering rate, steering velocity, and to adjust a rotational or lateral movement of the towing vehicle.

In still another aspect of the present disclosure, the method for intelligent vehicle precision controls further includes selectively toggling between and engaging one of a precision adjustment mode and a precision control mode based on a vehicle operator selection; and altering, in the precision adjustment mode, a scale and magnitude of vehicle operator inputs to the one or more actuators of the powertrain system and to the one or more actuators of the steering system.

In still another aspect of the present disclosure, the method for intelligent vehicle precision controls further includes adjusting, within the precision adjustment mode, the scale and magnitude of vehicle operator inputs is adjusted via one or more of a rotary knob and digital controls. Upon receiving a rightward or clockwise (CW) rotational input to the rotary knob or a rightward or spreading gesture to the digital controls, the method increases a scale of the vehicle operator inputs from a first level to a second level larger than the first level; and upon receiving a leftward or counterclockwise (CCW) rotational input to the rotary knob or a leftward or pinching gesture to the digital controls, the method decreases a scale of the vehicle operator inputs from the first level to a third level less than the first level.

In still another aspect of the present disclosure, the method for intelligent vehicle precision controls further includes continuously checking for movement of the rotary knob or movement of vehicle operator inputs to the digital controls for a predefined quantity of time within a timer or poller of the system, and upon detecting a movement, remaining within the timer, the method continues to check for movement, and continuing to alter a scale and magnitude of vehicle operator inputs; and upon detecting no movement within the predefined quantity of time of the timer or poller, exiting the precision mode of the IVPC application.

In still another aspect of the present disclosure, the method for intelligent vehicle precision controls further includes adjusting, within the precision control mode, the scale and magnitude of vehicle operator inputs via one or more of a rotary knob and digital controls, such that: upon receiving a vehicle operator's rightward or clockwise (CW) rotational input to the rotary knob or a rightward or spreading gesture to the digital controls, the method translate the rightward, CW, or spreading inputs or gestures into longitudinal forward movement commands to one or more actuators of the powertrain system or braking system, or into rightward or CW rotational commands to one or more actuators of the steering system; and upon receiving a vehicle operator's leftward or counterclockwise (CCW) rotational input to the rotary knob or a leftward or pinching gesture to the digital controls, the method translates the leftward, CCW, or pinching inputs or gestures into longitudinal rearward movement commands to the one or more actuators of the powertrain system or braking system, or into leftward or CCW rotational commands to the one or more actuators of the steering system.

In still another aspect of the present disclosure, the method for intelligent vehicle precision controls further includes continuously checking for movement of the rotary knob or movement of vehicle operator inputs to the digital controls for a predefined quantity of time within a timer or poller of the system, and upon detecting a movement, remaining within the timer, continuing to check for movement, and continuing to move the towing vehicle in accordance with the vehicle operator's inputs; and upon detecting no movement within the predefined quantity of time of the timer or poller, the method exits the precision mode of the IVPC application.

In still another aspect of the present disclosure, a method for intelligent vehicle precision controls, includes detecting static and dynamic state information about a towing vehicle with one or more sensors integrated into the towing vehicle, and altering the static and dynamic state of the towing vehicle with one or more actuators integrated into the towing vehicle. The method further includes executing, with a processor of a controller of the towing vehicle, program code portions stored in memory of the controller, the controller having input/output (I/O) ports in communication with the one or more sensors and the one or more actuators, the program code portions including an intelligent vehicle precision control (IVPC) application. The IVPC application further includes control logic for: engaging a precision mode of the IVPC application, including: receiving, via one or more human-machine interfaces (HMIs) in communication with the controller via the I/O ports, a vehicle operator input that engages the precision mode of the IVPC application. The one or more HMIs include control interfaces of the towing vehicle; an infotainment system of the towing vehicle; a heads-up display (HUD) of the towing vehicle; and vehicle operator-controllable input devices including: buttons, sliders, control wheels, haptic, audiovisual and/or voice-responsive interfaces, touch screens, mobile devices, mobile phones, laptops, and tablet computers. The method further includes monitoring, within the precision mode, towing vehicle hardware and determining that vehicle operator inputs to the IVPC application are being received via physical controls and/or digital controls, including: monitoring a powertrain system and a steering system of the towing vehicle for vehicle operator input sources, and upon determining that the vehicle operator inputs are being received from physical controls, utilizing a physical control mode of the IVPC application, and upon determining that the vehicle operator inputs are being received via digital controls, utilizing a digital control mode of the IVPC application. Physical controls include: physical HMIs including knobs, buttons, physical sliders, keypads, and directional pads (D-pads); and digital controls include: a touch-screen interface of the infotainment system of the towing vehicle, a touch-screen interface of one or more mobile devices, mobile phones, and laptops. The method further includes prompting the vehicle operator to select between at least: longitudinal inputs and steering inputs, including: upon receiving a longitudinal input from the vehicle operator, engaging actuators of the powertrain system and a braking system of the towing vehicle to generate torque to wheels of the towing vehicle to move forward or backwards; and upon receiving a steering input from the vehicle operator, engaging actuators of the steering system of the towing vehicle to alter a steering rate, steering velocity, and to adjust a rotational or lateral movement of the towing vehicle. The method further includes receiving vehicle operator inputs to selectively toggle between and engage one of a precision adjustment mode and a precision control mode based on a vehicle operator selection; and altering, in the precision adjustment mode, a scale and magnitude of vehicle operator inputs to the one or more actuators of the powertrain system and to the one or more actuators of the steering system. The method further includes adjusting, within the precision adjustment mode, the scale and magnitude of vehicle operator inputs is adjusted via one or more of a rotary knob and digital controls. Upon receiving a rightward or clockwise (CW) rotational input to the rotary knob or a rightward or spreading gesture to the digital controls, a scale of the vehicle operator inputs is increased from a first level to a second level larger than the first level. Upon receiving a leftward or counterclockwise (CCW) rotational input to the rotary knob or a leftward or pinching gesture to the digital controls, a scale of the vehicle operator inputs is decreased from the first level to a third level less than the first level. The method further includes continuously checking for movement of the rotary knob or movement of vehicle operator inputs to the digital controls for a predefined quantity of time within a timer or poller of the system, and upon detecting a movement, remaining within the timer, continuing to check for movement, and continuing to alter a scale and magnitude of vehicle operator inputs. Upon detecting no movement within the predefined quantity of time of the timer or poller, exiting the precision mode of the IVPC application; and adjusting, within the precision control mode, the scale and magnitude of vehicle operator inputs via one or more of a rotary knob and digital controls. Upon receiving a vehicle operator's rightward or clockwise (CW) rotational input to the rotary knob or a rightward or spreading gesture to the digital controls, the method translates the rightward, CW, or spreading inputs or gestures into longitudinal forward movement commands to one or more actuators of the powertrain system or braking system, or into rightward or CW rotational commands to one or more actuators of the steering system. Upon receiving a vehicle operator's leftward or counterclockwise (CCW) rotational input to the rotary knob or a leftward or pinching gesture to the digital controls, the method translates the leftward, CCW, or pinching inputs or gestures into longitudinal rearward movement commands to the one or more actuators of the powertrain system or braking system, or into leftward or CCW rotational commands to the one or more actuators of the steering system. The method further includes continuously checking for movement of the rotary knob or movement of vehicle operator inputs to the digital controls for a predefined quantity of time within a timer or poller of the system, and upon detecting a movement, remaining within the timer, continuing to check for movement, and continuing to move the towing vehicle in accordance with the vehicle operator's inputs. Upon detecting no movement within the predefined quantity of time of the timer or poller, the method exits the precision mode of the IVPC application and precisely maneuvering the towing vehicle, through the IVPC application, to a position where the towing vehicle and a trailer are aligned to be connected via a hitch.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for intelligent vehicle precision controls according to an exemplary embodiment;

FIG. 2A is a flowchart depicting a method for intelligent vehicle precision control according to an exemplary embodiment;

FIG. 2B is a flowchart depicting a precision toggle portion of the method of FIG. 2A according to an exemplary embodiment; and

FIG. 2C is a flowchart depicting a rotary knob control portion of the method of FIG. 2A according to an exemplary embodiment.

### DETAILED DESCRIPTION

The following description is merely exemplary in nature and is not intended to limit the present disclosure, application, or uses.

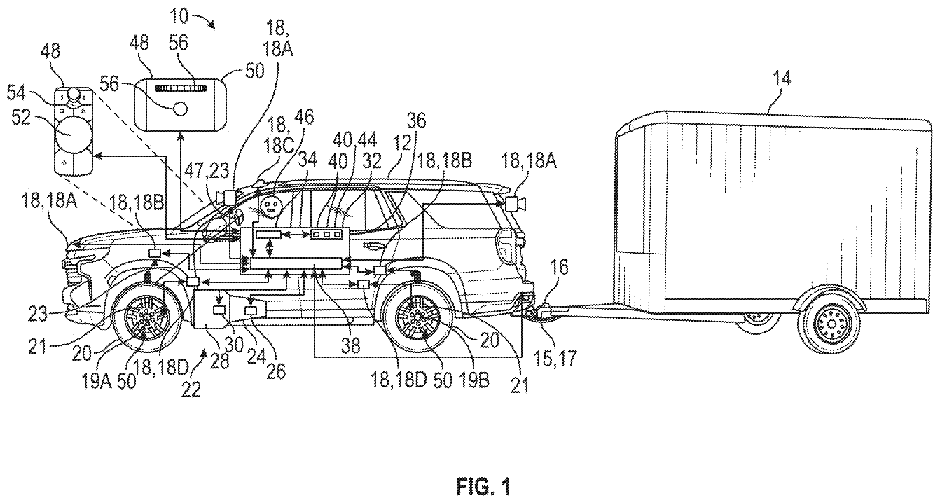

Referring to FIG. 1, a system 10 for intelligent vehicle precision controls is shown in schematic form. The system 10 includes a towing vehicle 12 that is connectable to a trailer 14 via a hitch 16. The towing vehicle 12 is illustrated as a passenger vehicle, however, it should be appreciated that the towing vehicle 12 may be any type of vehicle, including but not limited to: cars, trucks, sport utility vehicles (SUVs), vans, motor homes, semis, tractor-trailers, delivery vehicles including vehicles used within warehouses, tricycles, motorcycles, planes, amphibious vehicles, or any other such towing vehicle 12 which both makes contact with the ground and which may be connected to a trailer 14. Similarly, the trailer 14 is depicted as a vehicle hauling trailer or flatbed trailer, however it should be appreciated that the trailer 14 may be any type of trailer 14, including but not limited to: enclosed trailers, dump trailers, flatbed trailers, utility trailers, Conestoga trailers, car trailers, multi-vehicle trailers, lowboy trailers, refrigerated trailers, boat trailers, landscape trailers, car hauling trailers, gooseneck trailers, and the like. The hitch 16 is depicted as a receiver hitch with a ball attachment, however it will be appreciated that the hitch 16 may be any of a wide variety of hitches 16 such as receiver hitches, 5^{th} wheel hitches, gooseneck hitches, weight distribution hitches, pintle hitches, or the like. The towing vehicle 12 to trailer 14 connection is further augmented by one or more restraining or safety devices 15 which may include chains 17, ropes, or the like, without limitation or reservation. It should further be appreciated that while the term “trailer” is used herein, the system 10 is intended to operate with any towed or towable object or device, including but not limited to towed vehicles 12′, trailers 14, boats, aircraft, and the like.

The system 10 further includes one or more sensors 18 integrated into the towing vehicle 12 and/or the trailer 14. The sensors 18 detect static and dynamic information about the towing vehicle 12 and trailer 14, and may include, but are not limited to: electromagnetic (EM) sensors 18A such as cameras, infra-red cameras, video cameras, light detection and ranging (LiDAR) sensors, radio detection and ranging (RADAR) sensors, sound navigation and ranging (SONAR) sensors, and the like. EM sensors 18A, such as those described above, may be used to determine a proximity of the towing vehicle 12 and/or trailer 14 to one another, and/or to objects in the environment surrounding the towing vehicle 12 and/or trailer 14. The sensors 18 may further include sensors 18 capable of directly and/or indirectly measuring towing vehicle 12 and trailer 14 static and dynamic states, including but not limited to: inertial measurement units (IMUs), suspension sensors 18B and control units such as Semi Active Damping Suspension (SADS), air suspension sensors, continuous damping control (CDC) ride height sensors, global positioning system (GPS) sensors 18C, wheel 20 speed and/or brake 21 sensors 18D capable of measuring rotational speeds and/or torque being currently supplied to one or more of the wheels 20 or axles 19A, 19B of the towing vehicle 12, throttle position sensors, accelerator pedal position sensors, steering position sensors capable of measuring a steering system 23 position, steering rate, and steering velocity, tire pressure monitoring systems, aerodynamic element position sensors, and the like. In several examples, the suspension sensors 18B and control units such as Semi Active Damping Suspension (SADS), air suspension sensors, continuous damping control (CDC) ride height sensors, and the like define towing vehicle 12 axle load detecting equipment, capable of monitoring a vertical or normal force loading of the suspension of the towing vehicle 12. More specifically, the suspension sensors 18B and control units such as Semi Active Damping Suspension (SADS), air suspension sensors, CDC ride height sensors, and the like of exemplary non-limiting embodiments are capable of directly and/or indirectly measuring a vertical or normal force loading and/or a vertical displacement or ride height of a front axle 19A and a rear axle 19B of the towing vehicle 12.

The IMUs can measure movement, acceleration, and the like in several degrees of freedom. In a specific example, the IMUs may measure position, movement, acceleration, etc. in at least three degrees of freedom. Likewise, the SADS sensors may be IMUs capable of measuring in three or more degrees of freedom. In some examples, the SADS may be suspension hub accelerometers, or the like. Accordingly, towing vehicle 12 state information may include any of a wide variety of data including but not limited to: wheel 20 speed data, SADS, GPS, and IMU data including attitude, acceleration, location, and the like. The sensors 18 may further include towing vehicle 12 powertrain system 22 sensors, including but not limited to transmission 24 sensors 26, engine 28 control sensors 30, and the like without departing from the scope or intent of the present disclosure. Powertrain system 22 sensors detect a state of the powertrain system 22, including a quantity of torque being currently produced by the engine 28, motor, or other prime mover of the towing vehicle 12. Similarly, transmission 24 sensors 26 detect a state of the transmission 24 of the towing vehicle 12, including a state of a torque multiplier, such as a gear ratio currently engaged within the transmission 24 of the towing vehicle 12.

The system 10 further includes one or more controllers 32 in communication with the various sensors 18 of the towing vehicle 12 and/or trailer 14, processes information received therefrom, and generates output signals that are used to control or alter performance of the towing vehicle 12 and/or trailer 14. The controllers 32 are integrated into the towing vehicle 12. More specifically, the controllers 32 are non-generalized, electronic control devices having a preprogrammed digital computer or processor 34, non-transitory computer readable medium or memory 36 used to store data such as control logic, software applications, instructions, computer code, data lookup tables, etc., and input/output (I/O) ports 38. Computer readable medium or memory 36 includes any type of medium capable of being accessed by a computer, such as read only memory (ROM), random access memory (RAM), a hard disk drive, a compact disc (CD), a digital video disc (DVD), or any other type of memory. A “non-transitory” computer readable memory 36 excludes wired, wireless, optical, or other communication links that transport transitory electrical or other signals. A non-transitory computer readable memory 36 includes media where data can be permanently stored, and media where data can be stored and later overwritten, such as a rewritable optical disc or an erasable memory device. Computer code includes any type of program code, including source code, object code, and executable code. The processor 34 is configured to execute the code or instructions. The towing vehicle 12 may have additional controllers 32 such as a dedicated Wi-Fi controller, an engine control module, a transmission control module, a body control module, an infotainment control module, or the like. The I/O ports 38 may be configured to communicate via wired communications, wirelessly via Wi-Fi protocols under IEEE 802.11x, or the like without departing from the scope or intent of the present disclosure.

The controller 32 further includes one or more applications 40. An application 40 is a software program configured to perform a specific function or set of functions. The application 40 may include one or more computer programs, software components, sets of instructions, procedures, functions, objects, classes, instances, related data, or portions thereof adapted for implementation in a suitable computer readable program code. The applications 40 may be stored within the memory 36 or in additional or separate memory 36. Examples of applications 40 include audio or video streaming services, games, browsers, social media, etc. In other examples, the applications 40 are used to manage body control system functions, suspension control system functions, transmission and/or engine control system functions or the like in an exemplary towing vehicle 12.

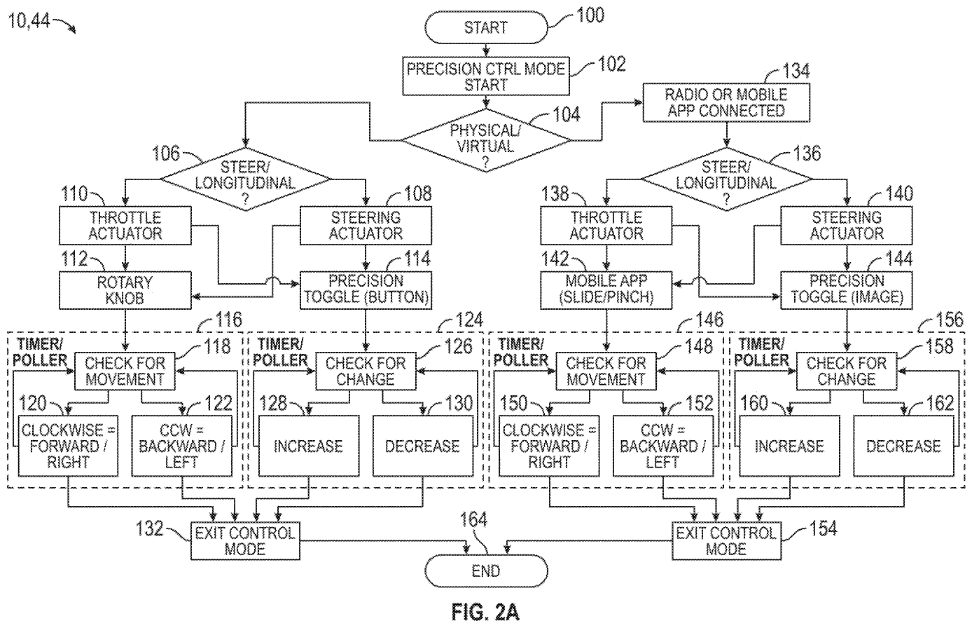

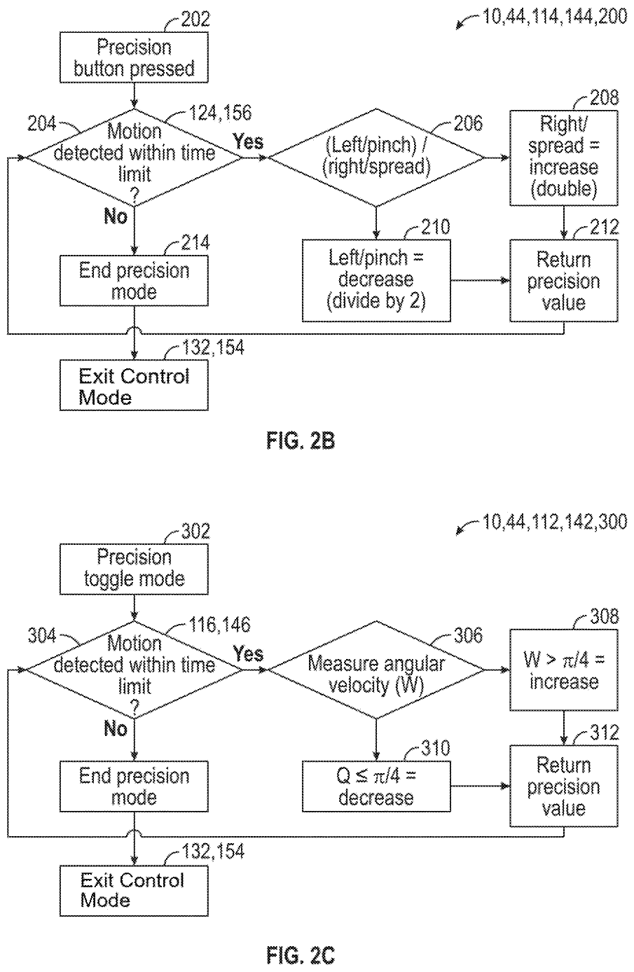

Referring now to FIG. 2A, the system 10 utilizes at least one intelligent vehicle precision control (IVPC) application 44 stored in memory 36 of the controller 32 to assist a vehicle operator 46 in precisely moving and positioning the host vehicle 12 so that the vehicle 12 may be properly connected to a trailer 14. More specifically, the IVPC application 44 monitors the hitch 16 through collection of at least optical information gathered from one or more of the EM sensors 18A of the towing vehicle 12. However, it should be appreciated that the EM sensor 18A information gathered by the IVPC application 44 may include SONAR, LiDAR, RADAR, and/or ultrasonic information as well as, or in lieu of optical information.

The IVPC application 44 is displayed in FIG. 2A in flowchart form. The IVPC application 44 begins at block 100. At block 102, a vehicle operator 46 who intends to maneuver the towing vehicle 12 into a position where it may be hitched to a trailer 14, engages a precision mode of the IVPC application 44. The precision mode IVPC application 44 of the towing vehicle 12 provides a way for the vehicle operator 46 to very precisely manage movements of the towing vehicle 12, and to also scale or alter a scale and magnitude of torque and/or steering inputs from relatively large inputs that may be manually input during normal driving operations to very small and extremely precise movements during trailer-attachment procedures. That is, the IVPC application 44 precision mode allows a vehicle operator 46 to manually depress an accelerator pedal, brake pedal, or manually manipulate the hand wheel/steering wheel 47 of the towing vehicle 12, and/or to engage an advanced driver assistance system (ADAS) of the towing vehicle 12 to automatically, and/or selectively at least partially manually position the towing vehicle 12 precisely and accurately via actuation of the powertrain system 22 and/or steering system 23 actuators. In additional examples, the IVPC application 44 precision mode allows the vehicle operator 46 to at least partially remotely and/or autonomously correctly and precisely position the towing vehicle 12 via actuation of the powertrain system 22 and/or steering system 23 actuators. When the vehicle operator 46 utilizes the IVPC application 44 in an ADAS-assisted mode, the vehicle operator 46 may engage the powertrain system 22 and/or steering system 23 through digital means, such as through manipulating one or more controls of a human-machine interface (HMI) 48 that are in electronic, but not necessarily physical communication with the steering system 23 and or powertrain system 22 actuators. Steering system 23 actuators may include, but are not limited to power-assisted steering system actuators, such as motors, pumps, and the like for altering an angular position of one or more steerable wheels 20 of the towing vehicle 12, and thereby affecting a lateral or rotational direction of travel of the towing vehicle 12.

The IVPC application 44 may be initialized at block 102 through one or more HMIs 48. The HMIs 48 may include any of a variety of different types and formats of HMI 48 without departing from the scope or intent of the present disclosure. In some non-limiting examples, the HMI 48 may be one or more control interfaces built into the towing vehicle 12, the trailer 14, or the like. Such towing vehicle 12 and/or trailer 14 mounted devices may include an infotainment system, a heads-up-display and associated vehicle operator 46 controllable input devices (e.g. buttons, sliders, control wheels, haptic, audiovisual and/or voice-responsive interfaces), touch-screen interfaces, and the like. In additional non-limiting examples, the HMI 48 may be a mobile device 50 separate from the towing vehicle 12 and trailer 14, but electronically connected via wireless and/or wired connections to towing vehicle 12 control systems. The IVPC application 44 may be loaded into memory 36 of a controller 32 within the mobile device 50 and communicating with the controllers 32 of the towing vehicle 12. Such mobile devices 50 may include mobile phones, laptops, tablet computers, and the like without limitation.

Subsequently, at block 104, the IVPC application 44 monitors system 10 hardware and determines whether vehicle operator 46 control inputs to the IVPC application 44 are being received from one or more towing vehicle 12 physical controls or from one or more digital controls, such as a screen of the infotainment system, or a touch-screen or other such interface of the one or more mobile devices, such as mobile phones, laptops, tablets, and the like. More specifically, at block 104, the IVPC application 44 determines that vehicle operator 46 control inputs are being received from physical controls of the towing vehicle 12 when the vehicle operator 46 manipulates one or more physical HMIs 48, such as the knob 52, buttons 54, or the like. Additional physical controls may include keypads and/or directional pads (D-pads) of the infotainment system, mobile phone, laptop, tablet, or other such device. By contrast, when vehicle operator 46 control inputs are received via digital HMIs 48, such as a screen of towing vehicle's 12 infotainment system, a touch-screen or other such interface of the one or more mobile devices 50, such as mobile phones, laptops, tablets, and the like, then the IVPC application 44 determines that the control inputs are being received via digital controls. Upon determining at block 104 that the vehicle operator 46 intends to use physical controls, IVPC application 44 proceeds to block 106 where a physical control mode of the IVPC application 44 is used.

At block 106, the IVPC application 44 provides the vehicle operator 46 with one or more prompts requesting that the vehicle operator 46 select between one of: longitudinal inputs, and steering inputs. In several non-limiting examples, the one or more prompts may include audiovisual cues and/or request for input that may be emitted or presented to the vehicle operator 46 via any of the HMIs 48 of the system 10. Longitudinal inputs received from the vehicle operator 46 allow the vehicle operator 46 to engage actuators of the powertrain system 22 of the towing vehicle 12 to generate torque to the wheels 20, thereby causing the towing vehicle 12 to move in a longitudinal direction (i.e. forward or backwards). By contrast, steering inputs received from the vehicle operator 46 allow the vehicle operator 46 to engage actuators of the steering system 23 to alter a steering rate, and steering velocity, and to thereby adjust rotational and/or lateral movement of the towing vehicle 12. Accordingly, when at block 106, the vehicle operator 46 elects to make a steering input, the IVPC application 44 proceeds to block 108 where one or more steering actuators are engaged. By contrast, when at block 106, the vehicle operator 46 elects to make a longitudinal input, the IVPC application 44 proceeds to block 110 where one or more of a throttle actuator, a brake actuator, and a transmission actuator is engaged.

From either block 108 or 110, the IVPC application 44 proceeds to blocks 112 and 114. At block 112, the IVPC application 44 allows the vehicle operator 46 to adjust a position of the steering, and/or throttle of the towing vehicle 12 via manipulation of a rotary knob 52, or the like. The rotary knob 52 is an HMI 48 mounted to the towing vehicle 12. In several aspects, the rotary knob 52 is a part of an infotainment system within the towing vehicle 12. It will be appreciated that the term “rotary”, when applied to a knob, typically signifies a device having the ability to rotate about an axis, however, the rotary knob 52 herein may move in additional degrees of freedom. That is, the rotary knob 52 may also operate as a joystick having four or more degrees of freedom of lateral movement, and/or the rotary knob 52 may operate as an axially depressible button, providing the ability for the rotary knob 52 to not only be operated rotationally, but also laterally, longitudinally, and axially to maneuver between various options or functions and/or toggle between distinct options or functions. That is, at block 114, the vehicle operator 46 may, rather than engaging the rotary knob 52 to maneuver the towing vehicle 12, as will be described in further detail in relation to blocks 116-122 below, use one or more toggles, buttons 54, or a toggling function of the rotary knob 52 to toggle access to a precision adjustment mode within blocks 124-130, described in further detail below.

When at block 112, within a precision control mode of the IVPC application 44, the vehicle operator 46 engages the rotary knob 52, by physically turning the rotary knob 52, to adjust a steering or longitudinal position of the towing vehicle 12, the IVPC application 44 proceeds to block 116. Block 116 of the IVPC application 44 represents a timer or poller. The timer or poller monitors at least the rotary knob 52 for vehicle operator 46 input within a predefined and/or variable quantity of time. In some examples, the predefined and/or variable quantity of time may be defined by market research, user preferences, and/or may be preset to a specific quantity of time, such as three seconds. However, it should be appreciated that a three-second quantity of time is not intended to be limiting, and that variations in the quantity of time during which the timer/poller operates are within the scope and intent of the present disclosure. While the timer/poller is operating, the IVPC application 44 monitors vehicle operator 46 inputs by checking for movement of the rotary knob 52 at block 118. When a clockwise movement of the rotary knob 52 is detected at block 120, the IVPC application 44 translates the clockwise movement of the rotary knob 52 into longitudinal forward movement commands to the actuators of the powertrain system 22 of the towing vehicle 12, which subsequently generate torque to the wheels 20, thereby causing the towing vehicle 12 to move forward in an amount proportional to rotation of the rotary knob 52. By contrast, when a counter-clockwise (CCW) movement of the rotary knob 52 is detected at block 122, the IVPC application 44 translates the CCW movement of the rotary knob 52 into longitudinal rearward or backward movement commands to the actuators of the powertrain system 22 of the towing vehicle 12, which subsequently generate torque to the wheels 20, thereby causing the towing vehicle 12 to move backward or rearward in an amount proportional to rotation of the rotary knob 52.

Similarly, when at block 106 the vehicle operator 46 chooses to make steering inputs, subsequently at block 120, clockwise movement of the rotary knob 52 causes the IVPC application 44 to generate commands to actuators of the steering system 23 to turn steerable wheels 20 of the towing vehicle 12 to the right in an amount proportional to rotation of the rotary knob 52. At block 122, when CCW movement of the rotary knob 52 is received, the IVPC application 44 generates commands to the steering system 23 actuators that cause the steerable wheels 20 of the towing vehicle 12 to turn to the left in an amount proportional to rotation of the rotary knob 52.

Upon receiving vehicle operator 46 inputs to the rotary knob 52, the IVPC application 44 remains within the timer/poller 116 and returns to block 118 where the IVPC application 44 continuously checks for movement of the rotary knob 52. When no rotary knob 52 movement is detected at block 118 within the predefined and/or variable quantity of time defined within the timer/poller 116, the IVPC application 44 proceeds to block 132 where the precision control mode of the IVPC application 44 exits.

Referring once more to blocks 124-130, the vehicle operator 46 utilizes one or more toggles, buttons 54, or a toggling function of the rotary knob 52 to toggle access to a precision setting within blocks 124-130. Upon receiving an input from the vehicle operator 46 to engage a precision adjustment mode of rotary knob 52 based control within the IVPC application 44, the IVPC application enters a second timer/poller 124. The second timer/poller 124 operates in substantially the same manner as the timer/poller at block 116. However, it should be appreciated that the predefined and/or variable quantity of time of the second timer/poller 124 may be the same as or entirely different to the predefined and/or variable quantity of time of the timer/poller at block 116.

Within the precision adjustment mode of the rotary knob 52 at block 126, the IVPC application 44 monitors vehicle operator 46 inputs by checking for movement of the rotary knob 52. When a clockwise movement of the rotary knob 52 is detected at block 128, the IVPC application 44 increases a scaling factor, ratio, or gain between rotational movement of the rotary knob 52 and the scale of output commands to the actuators of the towing vehicle 12. The scaling factor, ratio, or gain defines a proportionality of movement of the rotary knob 52 to output commands to the actuators of the towing vehicle 12. Thus, the clockwise movement of the rotary knob 52 increases a scale of forward, rearward, or left/right movement commands to the actuators of the powertrain system 22 and/or steering system 23 of the towing vehicle 12, which may then cause the towing vehicle 12 to move forward, rearwards, and/or left/right, in proportion to the scaled inputs to the rotary knob 52, once the precision mode has been toggled off.

By contrast, when a counter-clockwise (CCW) movement of the rotary knob 52 is detected at block 130, the IVPC application 44 converts the CCW movement of the rotary knob 52 to decrease a scaling factor, ratio, or gain between rotational movement of the rotary knob 52 and the scale of output commands to the actuators of the towing vehicle 12. Thus, the CCW movement of the rotary knob 52 decreases a scale of forward or rearward movement commands to the actuators of the powertrain system 22 and/or steering system 23 of the towing vehicle 12, which may then cause the towing vehicle 12 to move forward, rearwards, and/or left/right, in proportion to the scaled inputs to the rotary knob 52, once the precision adjustment mode has been toggled off.

Upon receiving vehicle operator 46 inputs to the rotary knob 52 within the precision adjustment mode, the IVPC application 44 remains within the second timer/poller 124 and returns to block 126 where the IVPC application 44 continuously checks for movement of the rotary knob 52. When no rotary knob 52 movement is detected at block 126 within the predefined and/or variable quantity of time defined within the second timer/poller 124, the IVPC application 44 proceeds to block 132 where the precision control mode of the IVPC application 44 exits.

Referring once more to block 104, upon determining that the vehicle operator 46 control inputs to the IVPC application 44 are being received via one or more digital controls, the IVPC application 44 proceeds to block 134, where a digital control mode of the IVPC application 44 is used. At block 134, the system 10 and IVPC application 44 ensure that one or more of a radio, infotainment, and/or mobile portion of the IVPC application 44 is engaged, connected to, and communicating with controllers 32 of the towing vehicle 12. Subsequently, at block 138, the system 10 and IVPC application 44 provides the vehicle operator 46 with one or more prompts requesting that the vehicle operator 46 select between one of: longitudinal inputs, and steering inputs. Longitudinal inputs received from the vehicle operator 46 allow the vehicle operator 46 to engage actuators of the powertrain system 22 of the towing vehicle 12 to generate torque to the wheels 20, thereby causing the towing vehicle 12 to move in a longitudinal direction (i.e. forward or backwards). By contrast, steering inputs received from the vehicle operator 46 allow the vehicle operator 46 to engage actuators of the steering system 23 to alter a steering rate, and steering velocity, and to thereby adjust rotational and/or lateral movement of the towing vehicle 12. Accordingly, when at block 136, the vehicle operator 46 elects to make a throttle input, the IVPC application 44 proceeds to block 138 where one or more of a throttle actuator, a brake actuator, and a transmission actuator is engaged. By contrast, when at block 136, the vehicle operator 46 elects to make a steering input, the IVPC application 44 proceeds to block 140 steering actuators are engaged.

From either block 138 or 140, the IVPC application 44 proceeds to blocks 142 and 144. At block 142, the IVPC application 44 allows the vehicle operator 46 to adjust a position of the steering, and/or throttle of the towing vehicle 12 via manipulation of an on-screen control interface 56, such as a slider, rotary knob 52, virtual buttons, and/or via gesture-based pinch/slide controls, or the like. In several aspects, the on-screen control interface 56 may be displayed on a screen of the infotainment system of the towing vehicle 12, on a mobile device 50, or other such HMI 48, connected to the towing vehicle 12 controller 32 through wired and/or wireless connections. That is, at block 144, the vehicle operator 46 may, rather than engaging the on-screen control interface 56 to maneuver the towing vehicle 12, as will be described in further detail below, use one or more toggles, buttons 54, or a toggling function of the on-screen control interface 56 to toggle access to a precision setting, described in further detail below.

When at block 142, the vehicle operator 46 engages the on-screen control interface 56 to adjust a steering or longitudinal position of the towing vehicle 12, the IVPC application 44 proceeds to block 146. Block 146 of the IVPC application 44 represents a timer or poller. The timer or poller monitors at least the on-screen control interface 56 for vehicle operator 46 input within a predefined and/or variable quantity of time. In some examples, the predefined and/or variable quantity of time may be defined by market research, user preferences, and/or may be preset to a specific quantity of time, such as three seconds. However, it should be appreciated that a three-second quantity of time is not intended to be limiting, and that variations in the quantity of time during which the timer/poller operates are within the scope and intent of the present disclosure. While the timer/poller is operating, the IVPC application 44 monitors vehicle operator 46 inputs by checking for movement of the on-screen control interface 56 at block 148. When a clockwise, forward, or right-ward movement of the on-screen control interface 56 is detected at block 150, the IVPC application 44 translates the clockwise, forward, or right-ward movement of the on-screen control interface 56 into longitudinal forward movement commands to the actuators of the powertrain system 22 of the towing vehicle 12, which subsequently generate torque to the wheels 20, thereby causing the towing vehicle 12 to move forward in an amount proportional to the quantity of rotational input, forward input, or right-ward input to the on-screen control interface 56. By contrast, when a CCW, rearward, or left-ward movement of the on-screen control interface 56 is detected at block 152, the IVPC application 44 translates the CCW, rearward, or left-ward movement of the on-screen control interface 56 into longitudinal rearward or backward movement commands to the actuators of the powertrain system 22 of the towing vehicle 12, which subsequently generate torque to the wheels 20, thereby causing the towing vehicle 12 to move backward or rearward in an amount proportional to rotation of the on-screen control interface 56.

Similarly, when at block 140 the vehicle operator 46 chooses to make steering inputs, subsequently at block 150, clockwise, forward, or right-ward movement of the on-screen control interface 56 causes the IVPC application 44 to generate commands to actuators of the steering system 23 to turn steerable wheels 20 of the towing vehicle 12 to the right in an amount proportional to rotation of the on-screen control interface 56. At block 152, when a CCW, rearward, and/or left-ward input to the on-screen control interface 56 is received, the IVPC application 44 generates commands to the steering system 23 actuators that cause the steerable wheels 20 of the towing vehicle 12 to turn to the left in an amount proportional to rotation, rearward, or left-ward inputs to the on-screen control interface 56.

Upon receiving vehicle operator 46 inputs to the on-screen control interface 56, the IVPC application 44 remains within the timer/poller 146 and returns to block 148 where the IVPC application 44 continuously checks for movement of the on-screen control interface 56. When no on-screen control interface 56 movement is detected at block 148 within the predefined and/or variable quantity of time defined within the timer/poller 146, the IVPC application 44 proceeds to block 154 where the precision control mode of the IVPC application 44 exits.

Referring once more to block 144, the vehicle operator 46 utilizes one or more toggles, buttons, or a toggling function of the on-screen control interface 56 to toggle access to a precision adjustment mode of the IVPC application 44. Upon receiving an input from the vehicle operator 46 to engage the precision adjustment mode of on-screen control interface 56 based control within the IVPC application 44, the IVPC application enters a second timer/poller 156. The second timer/poller 156 operates in substantially the same manner as the timer/poller at block 146. However, it should be appreciated that the predefined and/or variable quantity of time of the second timer/poller 156 may be the same as or entirely different to the predefined and/or variable quantity of time of the timer/poller at block 146.

Within the precision adjustment mode of the on-screen control interface 56 at block 158, the IVPC application 44 monitors vehicle operator 46 inputs by checking for movement of the on-screen control interface 56. When a clockwise, forward, expanding, and/or right-ward movement of the on-screen control interface 56 is detected at block 160, the IVPC application 44 increases a scaling factor, ratio, or gain between rotational movement of the on-screen control interface 56 and the scale of output commands to the actuators of the towing vehicle 12. The scaling factor, ratio, or gain defines a proportionality of movement of the on-screen control interface 56 to output commands to the actuators of the towing vehicle 12. Thus, the clockwise, forward, expanding, and/or right-ward movement of the on-screen control interface 56 increases a scale of forward, rearward, or left/right movement commands to the actuators of the powertrain system 22 and/or steering system 23 of the towing vehicle 12, which may then cause the towing vehicle 12 to move forward, rearwards, and/or left/right, in proportion to the scaled inputs to the on-screen control interface 56, once the precision adjustment mode has been toggled off.

By contrast, when a CCW, rearward, left-ward, and/or contracting (i.e. pinching) movement of the on-screen control interface 56 is detected at block 162, the IVPC application 44 converts the CCW, rearward, left-ward, and/or contracting movement of the on-screen control interface 56 to decrease a scaling factor, ratio, or gain between rotational movement of the on-screen control interface 56 and the scale of output commands to the actuators of the towing vehicle 12. Thus, the CCW, rearward, left-ward, and/or contracting movement of the on-screen control interface 56 decreases a scale of forward or rearward movement commands to the actuators of the powertrain system 22 and/or steering system 23 of the towing vehicle 12, which may then cause the towing vehicle 12 to move forward, rearwards, and/or left/right, in proportion to the scaled inputs to the on-screen control interface 56, once the precision adjustment mode has been toggled off.

Upon receiving vehicle operator 46 inputs to the on-screen control interface 56 within the precision adjustment mode, the IVPC application 44 remains within the second timer/poller 156 and returns to block 158 where the IVPC application 44 continuously checks for movement of the on-screen control interface 56. When no on-screen control interface 56 movement is detected at block 158 within the predefined and/or variable quantity of time defined within the second timer/poller 156, the IVPC application 44 proceeds to block 154 where the precision control mode of the IVPC application 44 exits. From either of blocks 132 and 154, the IVPC application 44 proceeds to block 164, where the IVPC application 44 ends after the vehicle operator 46 has completed using the IVPC application 44 to align the towing vehicle 12 with the trailer 14.

Turning now to FIG. 2B and with continuing reference to FIGS. 1 and 2A, precision control, such as that initiated at blocks 114 and/or 144 of FIG. 2A within the IVPC application 44 is shown in additional detail in flowchart form as indicated generally by reference numeral 200.

At block 202 upon receiving a vehicle operator 46 input to the one or more toggles, buttons 54, or via a toggling function of the rotary knob 52, the precision adjustment mode of the IVPC application 44 is initiated. Subsequently at block 204, when motion is detected within the predetermined time limit defined by within the timers/pollers at blocks 124 and/or 156, the IVPC application 44 proceeds to block 206. At block 206, the vehicle operator 46 may input, via one or more screen-based HMIs 48 a pinching or leftward gesture and/or a spreading or rightward gesture. In several aspects, when a spreading or rightward gesture is used, the IVPC application 44 proceeds to block to block 208, where a magnification of the vehicle operator 46 input is initiated. That is, at block 208, when the vehicle operator 46 uses a spreading or rightward gesture, subsequent non-precision adjustment-based inputs are magnified or scaled up to increase a ratio of actuator outputs to steering and/or powertrain systems in relation to the vehicle operator 46 inputs. In a non-limiting example, the ratio may double with each subsequent spreading or rightward motion. By contrast, when at block 206, the vehicle operator 46 utilizes a pinching or leftward gesture, the system 10 and IVPC application 44 proceed to block 210, where subsequent non-precision adjustment-based inputs are un-magnified, scaled down, or otherwise reduced, to decrease a ratio of actuator outputs to steering and/or powertrain systems in relation to the vehicle operator 46 inputs. In a non-limiting example, the ratio may halve (i.e. be divided by 2) with each subsequent pinching or leftward motion. From each of blocks 208 and 210, the IVPC application 44 proceeds to block 212, where a revised precision value is used to scale vehicle operator 46 inputs to system 10 outputs to actuators of the towing vehicle 12. The IVPC application 44 subsequently returns to block 204 where the timer/poller at blocks 124 and/or 156 continue to monitor for movement. When no movement is detected within the predetermined amount of time defined within the timer/poller at blocks 124 and/or 156, the IVPC application 44 proceeds to block 214, where the precision adjustment mode of the IVPC application 44 exits.

Referring now to FIG. 2C, and with continuing reference to FIGS. 1, 2A, and 2B, a precision toggling mode of the IVPC application 44 is shown in additional detail in a flowchart generally indicated by reference numeral 300.

At block 302 upon receiving a vehicle operator 46 input to the one or more toggles, buttons 54, or via a toggling function of the rotary knob 52, the precision toggle or precision toggling mode of the IVPC application 44 is initiated. At block 304 the vehicle operator 46 may input, via one or more screen-based HMIs 48 one or more of a pinching, rearward sliding, left sliding, or leftward rotational gesture and/or a spreading, forward sliding, right sliding, or rightward rotational gesture. At block 304, when such motion is detected within the predetermined time limit defined by within the timers/pollers at blocks 116 and/or 146, the IVPC application 44 proceeds to block 306. At block 306, the IVPC application 44 monitors the vehicle operator 46 input and measures a velocity or angular velocity of the vehicle operator's 46 input. When the velocity or angular velocity (W) exceeds a predetermined threshold value, such as W>Π/4, a precision value is increased at block 308 from a first level to a second level greater than the first level. By contrast, when the angular velocity (W) is equal to or less than the predetermined threshold value, such as W≤Π/4, a precision value is decreased at block 310 from the first level to a third level less than the first level. From either of blocks 308 and 310, the IVPC application 44 proceeds to block 312 where a precision value is returned to the system 10, and the IVPC application 44 subsequently proceeds to block 304. By contrast, when at block 304, no movement is detected within the predetermined amount of time defined within the timer/poller at blocks 116 and/or 146, the IVPC application 44 proceeds to block 314, where the precision toggle mode of the IVPC application 44 exits.

A system 10 and IVPC application 44 for intelligent precision vehicle control of the present disclosure offer several advantages. These include increasing the ease, accuracy, and precision with which a towing vehicle 12 may be attached to the trailer 14 by a vehicle operator 46 while making use of existing hardware, and while maintaining or reducing system 10 complexity, maintaining or reducing manufacturing complexity, and which may be retrofitted to existing towing vehicles 12 that are equipped with appropriate hardware, may be remotely updatable, and that offer improved functionality and redundancy, while improving vehicle operator convenience, comfort, and satisfaction.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for intelligent vehicle precision controls, comprising:
a towing vehicle;
a trailer, connectable to the towing vehicle via a hitch;
one or more sensors integrated into the towing vehicle, the one or more sensors detecting static and dynamic state information about the towing vehicle;
one or more actuators integrated into the towing vehicle, the one or more actuators altering the static and dynamic state of the towing vehicle;
a controller having a processor, a memory, and input/output (I/O) ports, the I/O ports in communication with the one or more sensors and the one or more actuators, the processor executing program code portions stored in the memory, the program code portions including an intelligent vehicle precision control (IVPC) application comprising:
a first control logic for engaging a precision mode of the IVPC application;
a second control logic, within the precision mode of the IVPC application, that monitors system hardware and determines that vehicle operator inputs to the IVPC application are being received via physical controls and/or digital controls;
a third control logic, within the precision mode of the IVPC application, that prompts the vehicle operator to select between at least: longitudinal inputs and steering inputs;
a fourth control logic, within the precision control mode of the IVPC application, that receives vehicle operator inputs to toggle between a precision adjustment mode and a precision control mode; and
a fifth control logic that, in the precision control mode, causes vehicle operator inputs to engage the one or more actuators of a powertrain system and/or the one or more actuators of a steering system, wherein the vehicle operator inputs in the precision control mode cause the towing vehicle to move longitudinally via actuation of the one or more actuators of the powertrain system or braking system, and to turn or rotate the towing vehicle via actuation of the one or more actuators of the steering system, wherein through the IVPC application, the vehicle operator precisely maneuvers the towing vehicle to a position where the towing vehicle and the trailer are aligned to be connected at the hitch.

2. The system of claim 1, wherein the first control logic further comprises:
control logic that receives, via one or more human-machine interfaces (HMIs) in communication with the controller via the I/O ports, a vehicle operator input that engages the precision mode of the IVPC application, wherein the one or more HMIs comprise:
control interfaces of the towing vehicle; an infotainment system of the towing vehicle; a heads-up display (HUD) of the towing vehicle; and vehicle operator-controllable input devices including: buttons, sliders, control wheels, haptic, audiovisual and/or voice-responsive interfaces, touch screens, mobile devices, mobile phones, laptops, and tablet computers.

3. The system of claim 2, wherein the second control logic further comprises:
control logic that monitors the powertrain system and steering system of the towing vehicle for vehicle operator input sources, and upon determining that the vehicle operator inputs are being received from physical controls, utilizes a physical control mode of the IVPC application, and upon determining that the vehicle operator inputs are being received via digital controls, utilizes a digital control mode of the IVPC application, wherein
physical controls comprise: physical HMIs including knobs, buttons, physical sliders, keypads, and directional pads (D-pads); and
digital controls comprise: a touch-screen interface of the infotainment system of the towing vehicle, a touch-screen interface of one or more mobile devices, mobile phones, and laptops.

4. The system of claim 3, wherein the third control logic further comprises:
control logic that: upon receiving a longitudinal input from the vehicle operator, engaging actuators of the powertrain system and a braking system of the towing vehicle to generate torque to wheels of the towing vehicle to move forward or backwards; and
upon receiving a steering input from the vehicle operator, engaging actuators of the steering system of the towing vehicle to alter a steering rate, steering velocity, and to adjust a rotational or lateral movement of the towing vehicle.

5. The system of claim 4, wherein the fourth control logic further comprises:
control logic that selectively toggles between and engages one of a precision adjustment mode and a precision control mode based on a vehicle operator selection.

6. The system of claim 5, wherein the fourth control logic further comprises: control logic that, in the precision adjustment mode, alters a scale and magnitude of vehicle operator inputs to the one or more actuators of the powertrain system and to the one or more actuators of the steering system.

7. The system of claim 6, wherein within the precision adjustment mode, the scale and magnitude of vehicle operator inputs is adjusted via one or more of a rotary knob and digital controls, wherein
upon receiving a rightward or clockwise (CW) rotational input to the rotary knob or a rightward or spreading gesture to the digital controls, a scale of the vehicle operator inputs is increased from a first level to a second level larger than the first level; and
upon receiving a leftward or counterclockwise (CCW) rotational input to the rotary knob or a leftward or pinching gesture to the digital controls, a scale of the vehicle operator inputs is decreased from the first level to a third level less than the first level.

8. The system of claim 7, wherein the fourth control logic further comprises:
control logic for continuously checking for movement of the rotary knob or movement of vehicle operator inputs to the digital controls for a predefined quantity of time within a timer or poller of the system, and upon detecting a movement, remaining within the timer, continuing to check for movement, and continuing to alter a scale and magnitude of vehicle operator inputs; and
upon detecting no movement within the predefined quantity of time of the timer or poller, exiting the precision mode of the IVPC application.

9. The system of claim 6, wherein within the precision control mode, the scale and magnitude of vehicle operator inputs is adjusted via one or more of a rotary knob and digital controls, wherein
upon receiving a vehicle operator's rightward or clockwise (CW) rotational input to the rotary knob or a rightward or spreading gesture to the digital controls, translating the rightward, CW, or spreading inputs or gestures into longitudinal forward movement commands to one or more actuators of the powertrain system or braking system, or into rightward or CW rotational commands to one or more actuators of the steering system; and
upon receiving a vehicle operator's leftward or counterclockwise (CCW) rotational input to the rotary knob or a leftward or pinching gesture to the digital controls, translating the leftward, CCW, or pinching inputs or gestures into longitudinal rearward movement commands to the one or more actuators of the powertrain system or braking system, or into leftward or CCW rotational commands to the one or more actuators of the steering system.

10. The system of claim 8, wherein the fifth control logic further comprises:
control logic for continuously checking for movement of the rotary knob or movement of vehicle operator inputs to the digital controls for a predefined quantity of time within a timer or poller of the system, and upon detecting a movement, remaining within the timer, continuing to check for movement, and continuing to move the towing vehicle in accordance with the vehicle operator's inputs; and
upon detecting no movement within the predefined quantity of time of the timer or poller, exiting the precision mode of the IVPC application.

11. A method for intelligent vehicle precision controls, comprising:
detecting static and dynamic state information about a towing vehicle with one or more sensors integrated into the towing vehicle;
altering the static and dynamic state of the towing vehicle with one or more actuators integrated into the towing vehicle;
executing, with a processor of a controller of the towing vehicle, program code portions stored in memory of the controller, the controller having input/output (I/O) ports in communication with the one or more sensors and the one or more actuators, the program code portions including an intelligent vehicle precision control (IVPC) application comprising control logic for:
engaging a precision mode of the IVPC application;
monitoring, within the precision mode, towing vehicle hardware and determining that vehicle operator inputs to the IVPC application are being received via physical controls and/or digital controls;
prompting the vehicle operator to select between at least: longitudinal inputs and steering inputs;
receiving vehicle operator inputs to toggle between a precision adjustment mode that scales vehicle operator inputs, and a precision control mode that controls the towing vehicle; and
causing vehicle operator inputs to engage the one or more actuators of a powertrain system and/or the one or more actuators of a steering system, wherein the vehicle operator inputs in the precision control mode cause the towing vehicle to move longitudinally via actuation of the one or more actuators of a powertrain system or braking system, and to turn or rotate the towing vehicle via actuation of the one or more actuators of the steering system, wherein through the IVPC application, the vehicle operator precisely maneuvers the towing vehicle to a position where the towing vehicle and a trailer are aligned to be connected via a hitch.

12. The method of claim 11, further comprising:
receiving, via one or more human-machine interfaces (HMIs) in communication with the controller via the I/O ports, a vehicle operator input that engages the precision mode of the IVPC application, wherein the one or more HMIs comprise:
control interfaces of the towing vehicle; an infotainment system of the towing vehicle; a heads-up display (HUD) of the towing vehicle;
and vehicle operator-controllable input devices including: buttons, sliders, control wheels, haptic, audiovisual and/or voice-responsive interfaces, touch screens, mobile devices, mobile phones, laptops, and tablet computers.

13. The method of claim 12, further comprising:
monitoring the powertrain system and steering system of the towing vehicle for vehicle operator input sources, and upon determining that the vehicle operator inputs are being received from physical controls, utilizes a physical control mode of the IVPC application, and upon determining that the vehicle operator inputs are being received via digital controls, utilizes a digital control mode of the IVPC application, wherein:
physical controls comprise: physical HMIs including knobs, buttons, physical sliders, keypads, and directional pads (D-pads); and
digital controls comprise: a touch-screen interface of the infotainment system of the towing vehicle, a touch-screen interface of one or more mobile devices, mobile phones, and laptops.

14. The method of claim 13, further comprising:
upon receiving a longitudinal input from the vehicle operator, engaging actuators of the powertrain system and a braking system of the towing vehicle to generate torque to wheels of the towing vehicle to move forward or backwards; and
upon receiving a steering input from the vehicle operator, engaging actuators of the steering system of the towing vehicle to alter a steering rate, steering velocity, and to adjust a rotational or lateral movement of the towing vehicle.

15. The method of claim 14, further comprising:
selectively toggling between and engaging one of a precision adjustment mode and a precision control mode based on a vehicle operator selection; and
altering, in the precision adjustment mode, a scale and magnitude of vehicle operator inputs to the one or more actuators of the powertrain system and to the one or more actuators of the steering system.

16. The method of claim 15, further comprising:
adjusting, within the precision adjustment mode, the scale and magnitude of vehicle operator inputs is adjusted via one or more of a rotary knob and digital controls, wherein
upon receiving a rightward or clockwise (CW) rotational input to the rotary knob or a rightward or spreading gesture to the digital controls, a scale of the vehicle operator inputs is increased from a first level to a second level larger than the first level; and
upon receiving a leftward or counterclockwise (CCW) rotational input to the rotary knob or a leftward or pinching gesture to the digital controls, a scale of the vehicle operator inputs is decreased from the first level to a third level less than the first level.

17. The method of claim 16, further comprising:
continuously checking for movement of the rotary knob or movement of vehicle operator inputs to the digital controls for a predefined quantity of time within a timer or poller of the system, and upon detecting a movement, remaining within the timer, continuing to check for movement, and continuing to alter a scale and magnitude of vehicle operator inputs; and
upon detecting no movement within the predefined quantity of time of the timer or poller, exiting the precision mode of the IVPC application.

18. The method of claim 15, further comprising:
adjusting, within the precision control mode, the scale and magnitude of vehicle operator inputs via one or more of a rotary knob and digital controls, wherein:
upon receiving a vehicle operator's rightward or clockwise (CW) rotational input to the rotary knob or a rightward or spreading gesture to the digital controls, translating the rightward, CW, or spreading inputs or gestures into longitudinal forward movement commands to one or more actuators of the powertrain system or braking system, or into rightward or CW rotational commands to one or more actuators of the steering system; and
upon receiving a vehicle operator's leftward or counterclockwise (CCW) rotational input to the rotary knob or a leftward or pinching gesture to the digital controls, translating the leftward, CCW, or pinching inputs or gestures into longitudinal rearward movement commands to the one or more actuators of the powertrain system or braking system, or into leftward or CCW rotational commands to the one or more actuators of the steering system.

19. The method of claim 17, further comprising:
continuously checking for movement of the rotary knob or movement of vehicle operator inputs to the digital controls for a predefined quantity of time within a timer or poller of the system, and upon detecting a movement, remaining within the timer, continuing to check for movement, and continuing to move the towing vehicle in accordance with the vehicle operator's inputs; and
upon detecting no movement within the predefined quantity of time of the timer or poller, exiting the precision mode of the IVPC application.

20. A method for intelligent vehicle precision controls, comprising:
detecting static and dynamic state information about a towing vehicle with one or more sensors integrated into the towing vehicle;
altering the static and dynamic state of the towing vehicle with one or more actuators integrated into the towing vehicle;
executing, with a processor of a controller of the towing vehicle, program code portions stored in memory of the controller, the controller having input/output (I/O) ports in communication with the one or more sensors and the one or more actuators, the program code portions including an intelligent vehicle precision control (IVPC) application comprising control logic for:
engaging a precision mode of the IVPC application, including:
receiving, via one or more human-machine interfaces (HMIs) in communication with the controller via the I/O ports, a vehicle operator input that engages the precision mode of the IVPC application, wherein the one or more HMIs comprise:
control interfaces of the towing vehicle; an infotainment system of the towing vehicle; a heads-up display (HUD) of the towing vehicle; and vehicle operator-controllable input devices including: buttons, sliders, control wheels, haptic, audiovisual and/or voice-responsive interfaces, touch screens, mobile devices, mobile phones, laptops, and tablet computers;
monitoring, within the precision mode, towing vehicle hardware and determining that vehicle operator inputs to the IVPC application are being received via physical controls and/or digital controls, including:
monitoring a powertrain system and a steering system of the towing vehicle for vehicle operator input sources, and upon determining that the vehicle operator inputs are being received from physical controls, utilizes a physical control mode of the IVPC application, and upon determining that the vehicle operator inputs are being received via digital controls, utilizes a digital control mode of the IVPC application, wherein:
physical controls comprise: physical HMIs including knobs, buttons, physical sliders, keypads, and directional pads (D-pads); and
digital controls comprise: a touch-screen interface of the infotainment system of the towing vehicle, a touch-screen interface of one or more mobile devices, mobile phones, and laptops;
prompting the vehicle operator to select between at least: longitudinal inputs and steering inputs, including:
upon receiving a longitudinal input from the vehicle operator, engaging actuators of the powertrain system and a braking system of the towing vehicle to generate torque to wheels of the towing vehicle to move forward or backwards; and
upon receiving a steering input from the vehicle operator, engaging actuators of the steering system of the towing vehicle to alter a steering rate, steering velocity, and to adjust a rotational or lateral movement of the towing vehicle;
receiving vehicle operator inputs to selectively toggle between and engage one of a precision adjustment mode and a precision control mode based on a vehicle operator selection; and
altering, in the precision adjustment mode, a scale and magnitude of vehicle operator inputs to the one or more actuators of the powertrain system and to the one or more actuators of the steering system;
adjusting, within the precision adjustment mode, the scale and magnitude of vehicle operator inputs is adjusted via one or more of a rotary knob and digital controls, wherein
upon receiving a rightward or clockwise (CW) rotational input to the rotary knob or a rightward or spreading gesture to the digital controls, a scale of the vehicle operator inputs is increased from a first level to a second level larger than the first level; and
upon receiving a leftward or counterclockwise (CCW) rotational input to the rotary knob or a leftward or pinching gesture to the digital controls, a scale of the vehicle operator inputs is decreased from the first level to a third level less than the first level;
continuously checking for movement of the rotary knob or movement of vehicle operator inputs to the digital controls for a predefined quantity of time within a timer or poller of the system, and upon detecting a movement, remaining within the timer, continuing to check for movement, and continuing to alter a scale and magnitude of vehicle operator inputs; and
upon detecting no movement within the predefined quantity of time of the timer or poller, exiting the precision mode of the IVPC application; and
adjusting, within the precision control mode, the scale and magnitude of vehicle operator inputs via one or more of a rotary knob and digital controls, wherein:
upon receiving a vehicle operator's rightward or clockwise (CW) rotational input to the rotary knob or a rightward or spreading gesture to the digital controls, translating the rightward, CW, or spreading inputs or gestures into longitudinal forward movement commands to one or more actuators of the powertrain system or braking system, or into rightward or CW rotational commands to one or more actuators of the steering system; and
upon receiving a vehicle operator's leftward or counterclockwise (CCW) rotational input to the rotary knob or a leftward or pinching gesture to the digital controls, translating the leftward, CCW, or pinching inputs or gestures into longitudinal rearward movement commands to the one or more actuators of the powertrain system or braking system, or into leftward or CCW rotational commands to the one or more actuators of the steering system;
continuously checking for movement of the rotary knob or movement of vehicle operator inputs to the digital controls for a predefined quantity of time within a timer or poller of the system, and upon detecting a movement, remaining within the timer, continuing to check for movement, and continuing to move the towing vehicle in accordance with the vehicle operator's inputs; and
upon detecting no movement within the predefined quantity of time of the timer or poller, exiting the precision mode of the IVPC application; and
precisely maneuvering the towing vehicle, through the IVPC application, to a position where the towing vehicle and a trailer are aligned to be connected via a hitch.
